(19) United States
(12) Patent Application Publication
(10) Pub. No.: US 2009/0165601 A1
(43) Pub. Date: Jul. 2, 2009

(54) Backup wrench

(75) Inventor: Jonathan Douglas Bauman, Odessa, TX (US)

Correspondence Address: Jonathan Douglas Bauman, 709 W. 38th Street, Odessa, TX, 79764, US

(73) Assignee: Jonathan Douglas Bauman, Odessa, TX (US)

(21) Appl. No.: 11/975,111

(22) Filed: Dec. 26, 2007

(51) Int. Cl. B25B 13/02

(52) U.S. Cl. 81/119

(57) ABSTRACT

The benefit of and the practical side of the improvement, by adding the retaining shoulder to the jaws of the wrench on the box-end and the open-end parts of the wrench, is the decline of slippage and limited loss of control of the tightening or removal procedure, producing an ease of maintaining one's position on the bolt or nut when the vibration of an impact wrench is incorporated or manual procedures, no matter how precarious the position or how open the position is to the mechanic, technician, or untrained shop help. This Backup Wrench does not allow the nut or bolt to skip through the jaws of the wrench whether on open-end or box-end as it has a built-in stop. The stop holds the nut but alls the bolt to protrude without affecting the Backup Wrench's position. Sizes range from ¼″ on up to any size desired—American or Metric.

### CROSS REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

This invention targets the field of mechanics, assembly lines and any place where impact wrenches are used to tighten and loosen bolt and nut applications as an on-going process of production and maintenance.

The subject matter would be “Mechanics”, “Maintenance”, “Assembly Line”.

### BRIEF SUMMARY OF THE INVENTION

The main idea is to simplify the operation of one man operating an impact wrench with a back up wrench that does not easily slip off the nut while tightening the bolt to the desired torque. While not totally eliminating human error or slippage, this wrench is a great asset in the desired setting to improve productivity and ease of application. There is greater jaw strength in both open-end and box-end design by virtue of geometric design.

This idea was developed in a ‘rig-up’ truck shop where frame bolts had to be removed and replaced by one man in tight places. This type of wrench would be welcomed in any shop.

### BRIEF DESCRIPTION OF THE SEVERAL VIEWS OF THE DRAWING

FIG. 1 of 5 Top View Layout of Backup Wrench with box-end and open-end Features. It shows the head rotated at 18 degrees on the open-end. The box-end is straight. Looking at the jaw location on each end of the wrench, you can see the retainer portion that makes the wrench stay in place giving better control for the mechanic through increased jaw strength by virtue of geometric design.

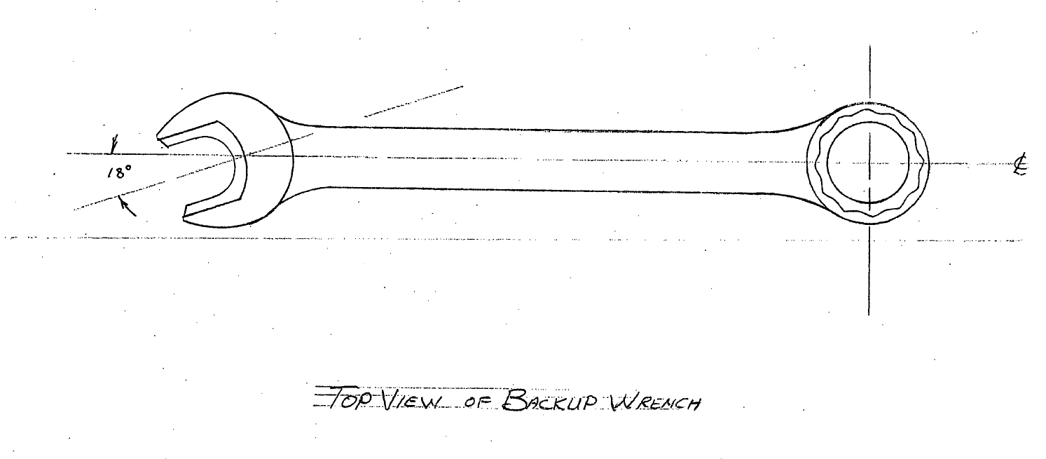

FIG. 2 of 5 Shows the “Backup Wrench” from the edge or side view. Hidden lines reflect the jaws of the “open-end” and “box-end” feature with the lower part showing the retainer shoulder that enables the wrench to better maintain position during use. This retainer shoulder is forged into the wrench as it is manufactured increasing jaw strength. The opening going through the wrench is sized to the bolt protrusion size plus ⅛″ with the jaw size to be nominal to the application of work.

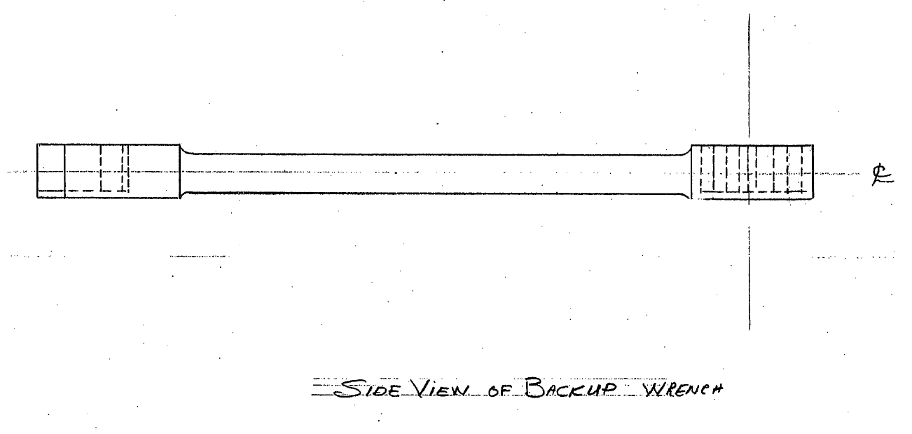

FIG. 3 of 5 Is a bottom view of the Backup Wrench. It shows the “open-end” and “box-end” feature and the retainer shoulder is more visible in this view. This view also reflects the rotation of the “open-end” feature, 18 degrees off center line. The built-in retainer shoulder increases jaw strength.

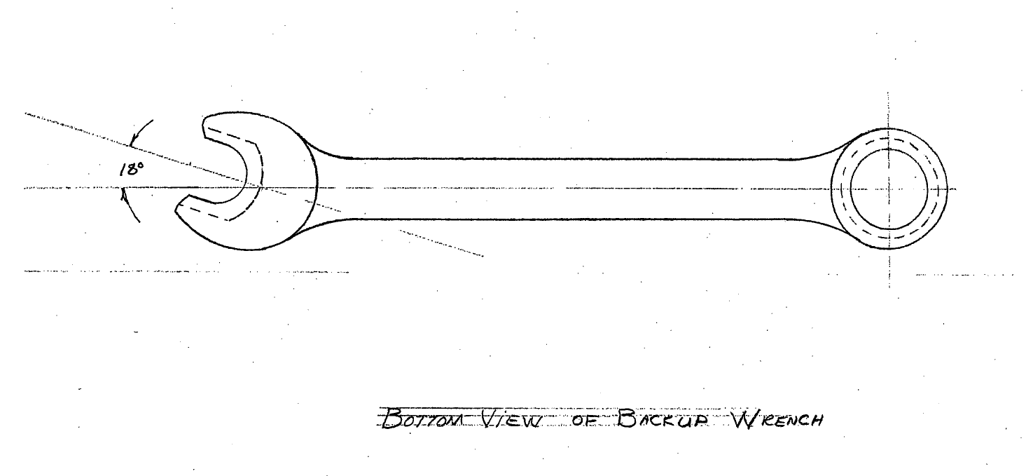

FIG. 4 of 5 This is an end view drawing of the “box-end” feature of the Backup Wrench showing the retainer shoulder on the left side of the drawing. It is forged in place at the time of manufacture of the Backup Wrench. It is a permanent entity of the Backup Wrench.

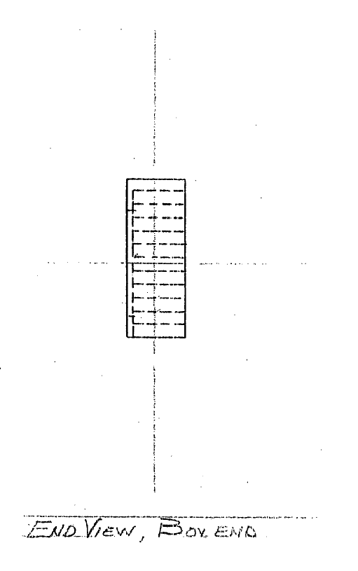

FIG. 5 of 5 This is an end view drawing of the Backup Wrench on the “open-end” feature. It shows the retainer shoulder on the left hand side of the drawing. It is a permanent forged entity of the wrench that occurs during manufacture of the wrench. In addition to holding it's position better, it is also stronger in the jaw area by virtue of design.

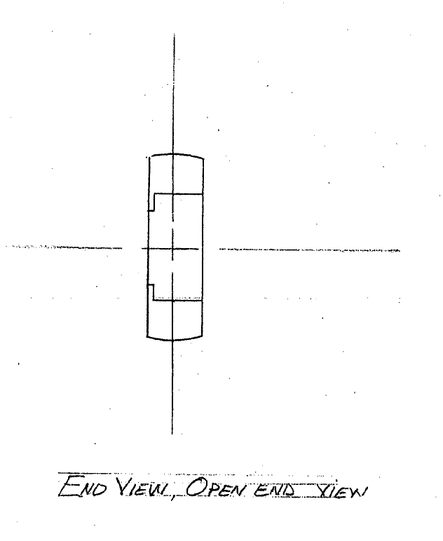

### DETAILED DESCRIPTION OF THE INVENTION

The focus of this description is the new and improved part of the basic wrench design to include a retainer shoulder to aid in the prevention of slippage of the wrench when an impact wrench is applied to the bolt for torqueing to the desired pressure. This retainer shoulder is evident in all views of the five drawings and is included in the forging of the wrench in the manufacturing of the wrench. There is increased jaw strength by virtue of geometric design.

1. Jonathan Douglas Bauman, claim this invention, the Backup Wrench., has a built-in shoulder on both ends of the wrench, “box-end” and “open-end”, to aid in the mechanic's ability to maintain control of the nut as an impact is applied to torque bolt to the desired torque and not losing position as the vibration is intensified through the tightening process. There is also increased jaw strength by virtue of design geometrics.
